(19) United States
(12) Patent Application Publication
(10) Pub. No.: US 2005/0203887 A1
(43) Pub. Date: Sep. 15, 2005

(54) System and method for seamless access to multiple data sources

(75) Inventors: Dinendra V. Joshi, Santa Clara, CA (US); Padmaja P. Dasari, Santa Clara, CA (US); Ashutosh R. Patil, Santa Clara, CA (US)

Correspondence Address: William L. Botjer, PO Box 478, Center Moriches, NY, 11934, US

(73) Assignee: SOLIX TECHNOLOGIES, INC., SANTA CLARA, CA (US)

(21) Appl. No.: 10/800,376

(22) Filed: Mar. 12, 2004

(51) Int. Cl. G06F 7/00

(52) U.S. Cl. 707/3

(57) ABSTRACT

A system and method for providing simultaneous or independent access to disparate data sources in a single login session. A user logs into a front-end application session using a custom responsibility. The user submits a query for accessing data from backend enterprise databases, which store current and archived data separately. The data query is channeled to an interoperable layer. The query is modified to a union query at the interoperable layer, to facilitate simultaneous access to current and archived data. This is done by constructing similar queries for accessing data from each of the multiple data sources. The queries are subsequently combined. Next, the union query is routed to the backend database servers which process the query and retrieve data from current as well as archive databases, in response to the query. The retrieved data is then integrated and presented to the user as an exhaustive search result.

### BACKGROUND

The present invention relates generally to accessing data repositories through enterprise applications. More specifically, the invention relates to a system and method for providing simultaneous or independent access to disparate data sources in a single login session.

The rapid growth of eBusiness over the recent years has led to the advent of a customer driven business environment and an increase in online transaction processing. In high volume Customer Relationship Management (CRM) and Enterprise Resource Planning (ERP) applications, an enormous amount of data needs to be stored. This storage is required not only for meeting customer requirements, but also to meet certain legal requirements set forth by government regulations. The data generated because of such applications is usually stored in production databases.

When the production data size grows excessively, enterprises typically purge and archive their historical data from their production database instance. This is because the traditional approach of storing all transaction data in the production database for querying and reporting is not efficient any more. Capacity expansion, intensive database tuning and more powerful processors just provide an interim solution. Database growth degrades performance and limits in-time availability of mission-critical data. Larger databases may take longer to load, unload, search and organize. Service levels thus deteriorate due to slow response time.

Data that enterprises don't purge from the production database is called Current data, i.e., data that is being currently worked on by enterprise users. Data that has been purged from the production database and archived is called Historical or Archived data e.g. closed transactions of prior business periods.

This transfer of data from the current database to the archive database is usually done depending on data usage. Typically, data that has not been accessed for a certain period is transferred to the archive database. This can be done on a periodic basis.

Databases (both current and archive) usually store data in either flat or relational format. In the flat format, data items are stored independently, i.e. without any relationship to other data items. In relational databases, i.e., databases storing data in the relational format, data items are stored along with their relationships with other data items. The relational format is more suitable for data items that have multiple attributes and bear multiple relationships with each other.

Conventionally, data management has been done through Hierarchical Storage Management (HSM). In HSM, archive data is put on offline storage devices such as tape drives thereby limiting the size of the current database. The limited size of the current database reduces the processing time for any request directed to such a database. However, HSM caters primarily to flat databases and does not provide an efficient solution for relational databases.

In recent times, ‘Active Archiving’ is being used for data archiving and purging. In active archiving, precise subsets of rarely used data are safely removed from complex relational databases. This historical data may then be stored in an archive database. The active archiving process saves metadata that describes tables, columns and relationships used to create the archive, along with the actual data. The archives are kept near-line or online and with the available information data that can be restored in its business context. Archived files can be put on a tape media and placed in a cache when data is referenced during an active period. Then it may be returned to the tape after the active period has passed. After initial archiving, active archiving may be regularly scheduled in order to help optimize database performance on a continuous basis.

A product that implements such an active archiving technique is Archive for Servers™, manufactured by Princeton Softech, Princeton, N.J., USA. This product is capable of safely removing complete sets of infrequently used data from production databases and storing them in readily accessible archives. In this manner, infrequently used data along with the metadata is saved to an archive file. During this process, a unique index corresponding to the location of archived data is created to track archived data and to retrieve it later on. The archived data can be accessed in real-time using the standard ODBC interface. Data can also be restored back to the live database, referentially intact. This reduces the data size that needs to be processed, hence resulting in faster response time and more efficient data retrieval. However, such a system allows access to limited amount of data. The archives are readily accessible, but while live data is being accessed, archived data is hidden from the users. Therefore, accessing the latter would require users to specifically look for the data in archives.

An archiving solution offering access to both live as well as archived data is XpressArchiver™, a product manufactured by Applimation Inc., NY, USA. This product removes inactive data from the live system and archives it to a read-only database. The complete data set is then made accessible to the users simultaneously, but with read-only permissions to the archives. This helps in reducing the processing complexities to a certain extent. However, users are provided with separate access permissions to access live and archive databases.

CheckMate Suite™, offered by BitbyBit International Ltd. (now a subsidiary of Outerbay Technologies, Campbell, USA) provides the option of simultaneous access to history data from the current application, in addition to the usual archiving and purging facilities. This is achieved through the “Joined Application” methodology, for users who need access to the entire dataset. Here, the database is effectively partitioned into the live and historical data sets. Once data has been moved across to the archive, a ‘joined schema’ is established, whereby a ‘virtual’ complete database of live and history data is created. Everyday users and processes need to interact only with the live database. For other users, who need to access the entire database, union views to both sets of tables in live and history are provided, and queries are run against the full dataset. Such a scheme does provide an option of accessing the entire dataset, but at the expense of performance, since the entire dataset would take a considerable time to be searched through. Furthermore, once a user logs in with the privilege of accessing the entire dataset, he cannot access current and archived data sources independently in the same session.

In light of the above discussion, there is a need for a system and methodology that provides simultaneous access to current as well as archive databases, without compromising on the performance aspects. In other words, the entire dataset must be made available to the users simultaneously, while still maintaining good response times and less processing overheads. Furthermore, the users need to be able to access archived as well as current databases seamlessly within the same session.

### SUMMARY

An object of the present invention is to facilitate seamless data access to disparate data sources.

Another object of the invention is to provide access to combined data from the current and archived enterprise databases in a single login session, without the need for separately accessing these databases.

A further object of the invention is to enable a user to execute reports and use forms or screens that have access to both current and archived data.

The present invention achieves these objectives through an interoperable layer that sits in between a front-end application session and the backend database servers. When a user logs in with a specially defined custom responsibility for accessing combined data, the data queries received by the application session are channeled through the interoperable layer before being processed. The interoperable layer modifies data queries to facilitate simultaneous access to disparate data sources, i.e. current and archive databases. This is done by constructing queries specific to each database for accessing data related to the query. Next, the queries are integrated into a union query. This union query is then processed at the backend server and an exhaustive search is made. The retrieved data is then combined and presented to the user. In this manner, the present invention provides an enterprise with an alternative to maintaining current and historical data separately to improve performance and availability of critical data, and still be able to provide exhaustive search results, when required. Furthermore, it provides the user with enough flexibility to access current and archived data simultaneously or independently without the need to log in separately each time.

### BRIEF DESCRIPTION OF THE DRAWINGS

The preferred embodiments of the invention will hereinafter be described in conjunction with the appended drawings provided to illustrate and not to limit the present invention, wherein like designations denote like elements, and in which:

FIG. 1 is a block diagram that provides an overview of the enterprise application environment in which the present invention operates;

FIG. 2 illustrates an exemplary enterprise application environment in which the present invention may operate;

FIG. 3 is a schematic representation of an embodiment of the backend databases;

FIGS. 4a and 4b schematically describe some of the possible configurations in which backend databases may be organized;

FIG. 5 is a logic flow diagram that illustrates the architecture of the interoperable layer architecture and describes the operation of an embodiment of the system as illustrated by FIG. 1; and

FIG. 6 is a flowchart that illustrates the seamless data access feature of the interoperable layer by means of an example.

### DESCRIPTION OF PREFERRED EMBODIMENTS

The present invention is directed to a method and system for simultaneous access to disparate data sources. Typically, large databases maintain relatively inactive data in archives, separate from the live (i.e. current) data. The invention provides users with simultaneous access to archived data along with live data. This functionality is achieved through an interoperable layer, which provides the application session with an integrated view of the current as well as the archived data.

The present invention finds particular application in seamless data access to backend databases for enterprise applications. Enterprise applications include integrated packages for enterprise resource planning, customer relationship management and the like. Such applications can perform multiple functions such as managing inventories of day-to-day transactions with customers, keeping track of purchase and billing details or facilitating payroll and asset management. Oracle eBusiness Suite, PeopleSoft Application Solutions, SAP Supply Chain Management Solutions are some examples of commercially available enterprise applications. In the context of an enterprise application, the present invention facilitates exhaustive data searches to be made from backend databases (i.e. both live as well as archived) within a single login session. Therefore, users do not need to log in separately for accessing current and archive databases.

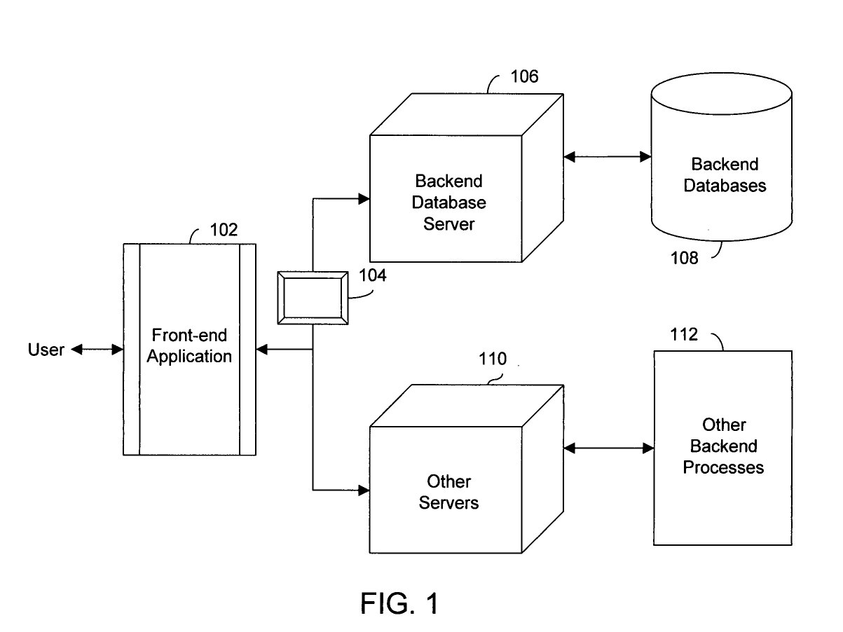

FIG. 1 is an overview of the enterprise application environment in which the present invention operates. A user interacts with a front-end application 102 and submits data queries to the application session. These queries specify the data items that have to be extracted along with the data source that needs to be searched. In the context of enterprise applications, such a query may relate to the history of a particular client, the details of transactions held in a particular sales department and other relevant data. These queries are submitted either in a predefined form or a report. User requests are interpreted at front end 102 and converted to a standard query format, using a standard query language.

The queries are then channeled through an interoperable layer 104. Interoperable layer 104 modifies the native data queries to form unified data queries for enabling data access from disparate data sources. In other words the standard queries capable of accessing a single data source are modified in a manner such that they can access a plurality of data sources simultaneously. The modified queries are thereafter routed through backend server 106 to databases 108 where the requested data resides. Other backend servers 110 execute other backend processes 112. The data retrieved from databases 108 is then routed back to application session 102 where it is displayed to the user. Backend databases 108 are relational databases implying that each data item has multiple attributes and relationships with other data items. Examples of such databases include Sybase, Oracle and other similar commercially available database management systems (DBMS). However, it would be evident to one skilled in the art that the embodiments mentioned here are only exemplary in nature and in no way limit the scope of the invention. The methodology of the present invention may be applicable to other types of databases including multidimensional flat databases, hierarchical databases and the like with minor modifications.

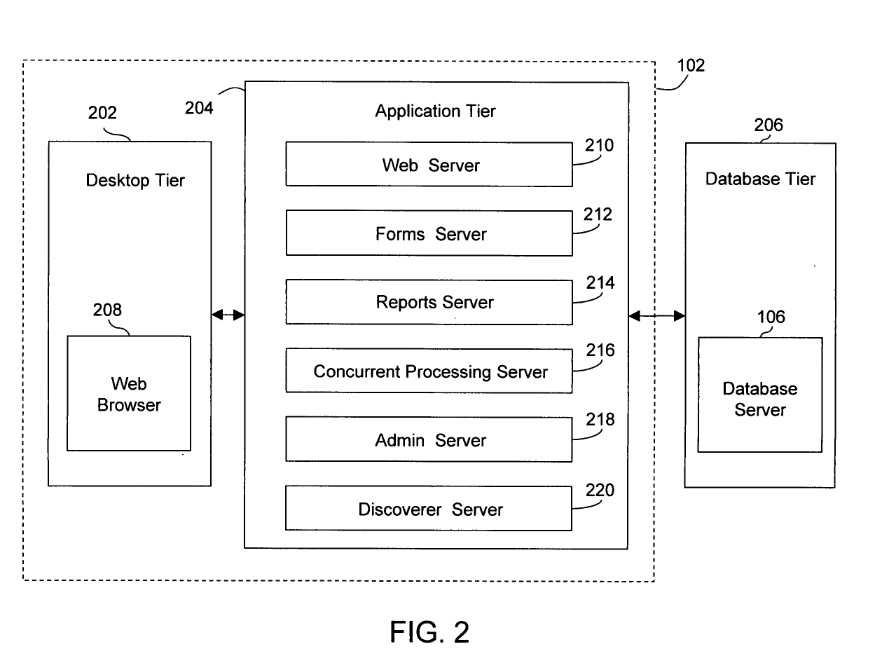

FIG. 2 illustrates an exemplary enterprise application environment in which the present invention may operate. Desktop tier 202 and application tier 204 collectively represent front-end application 102. The user interacts with the system through web browser 208, which acts as the front-end user interface. Application tier 204 constitutes a plurality of servers with varied functionalities that enable querying of data. Examples of these servers include Web Server 210 that enables web access, Forms Server 212 that enables forms execution, Reports Server 214, Admin Server 218 etc. Database tier 206 includes various backend database servers 106 controlling access to backend databases 108. Interoperable layer 104 may be implemented between application tier 204 and database tier 206.

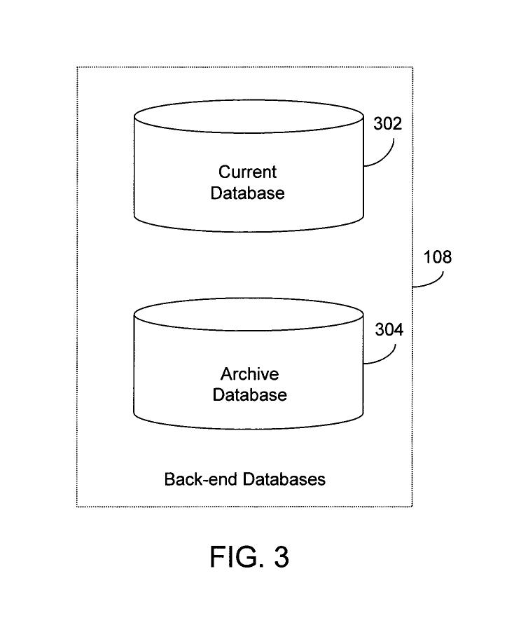

FIG. 3 is a schematic representation of an embodiment of the backend databases. These databases are accessed by the modified query, which is routed from interoperable layer 104. Backend databases 108 include a current database 302 and an archive database 304. Current database 302 houses live data, which is actively being used by application users. Archive database 304 constitutes historical data that originally resided in the current database e.g. data pertaining to closed transactions of prior business periods. As the data becomes obsolete or inactive over a period, it is removed or purged from current database 302 and moved to archive database 304. As is evident to one skilled in the art, this is achieved through an automated archive-and-purge process by the system. Archiving and purging are also often automated for a specified time interval i.e. data items dating back before a certain time period may be deemed to be historical data. Other parameters are also used as bases for archiving current data items.

The identified data items are then purged from current database 302 and sent to archive database 304. In case of relational databases, where data items have multiple attributes and complex relationships, primary and foreign keys are used to preserve relationships between current and archived data. A primary key is a unique identifier of a data item, while a foreign key identifies its relationship with other data items. The relationship details are maintained in the archived and purged data and this data is identified by the same relationships (based on the primary and foreign key relationships) as the current data.

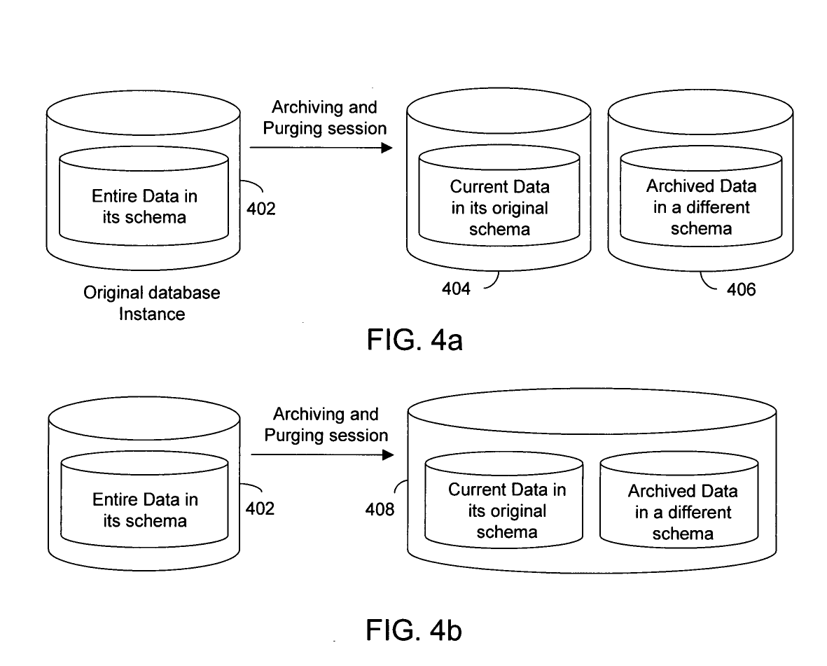

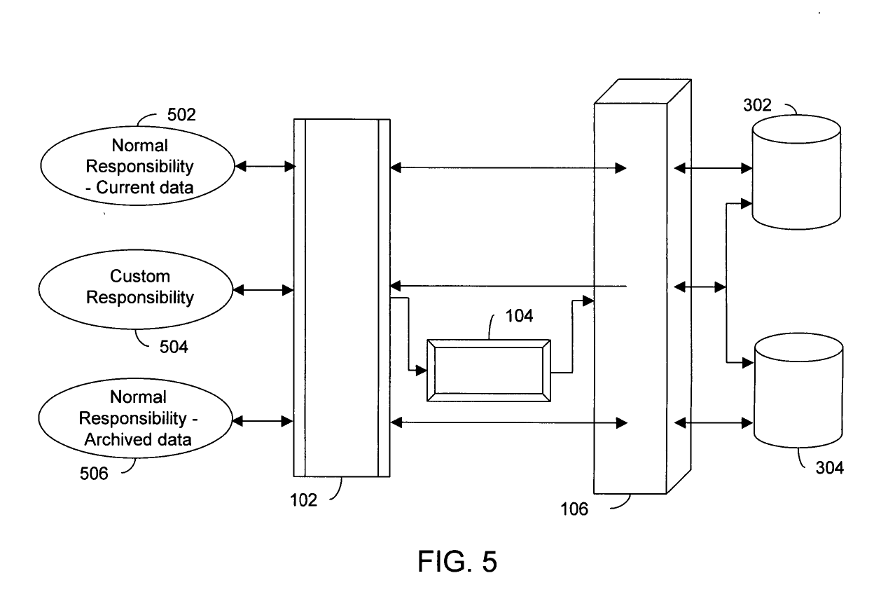

FIGS. 4a and 4b schematically describe some of the possible configurations in which backend databases 108 may be organized. In order to implement the present invention, backend database 402 may be archived in any manner. For example, historical data may be archived as a different database instance 406, which is physically separate from current database instance 404, as illustrated in FIG. 4a. This improves the overall database performance, when only the current data needs to be accessed, by reducing the overall data access time. Alternatively, the historical data may be archived within the same database instance using a different schema, as illustrated in FIG. 4b. This improves the independent table performance by removing some data and putting it in a different schema. Furthermore, it eliminates the need to maintain separate database instances. In either case, the present invention would be equally effective in retrieving combined data. This is because interoperable layer 104 suitably routes union data queries to the pertinent databases and provides a combined view of the retrieved data. This functionality of the interoperable layer is further explained in conjunction with FIG. 5.

FIG. 5 is a logic flow diagram that illustrates the architecture of the interoperable layer and describes the operation of an embodiment of the system as illustrated by FIG. 1. A user logs into the enterprise application with an application role or a responsibility. The responsibility defines the scope and functionality of the application to which the user has access. It will be obvious to one skilled in the art that a user needs to be authenticated via a responsibility prior to database access. In order to access the combined data via interoperable layer 104, the user needs to log in with a specially defined custom responsibility 504. Queries channeled via such a responsibility are routed to interoperable layer 104, which facilitates simultaneous or independent data access within the same login session. On the contrary, queries channeled via normal responsibilities are directly routed to one of the databases and fetch results from that database only. Interoperable layer 104 does not interact with any responsibilities other than the special custom responsibilities. Data queries called with a responsibility 502 for accessing the current database are routed to current database 302 via backend server 106. Here queries are in the form of SQL, DML, or DDL statements, which can be taken by any standard query processor. Similarly data queries called with a responsibility 506 for accessing archives are routed to archive databases 304 via database server 106.

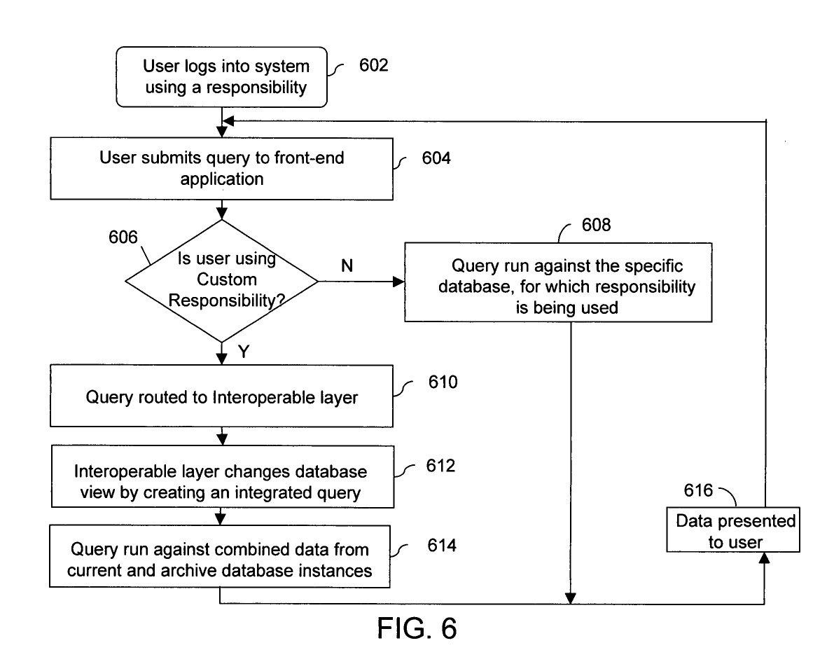

However, a custom responsibility 504 for accessing combined data routes data queries to interoperable layer 104. Here, the query instructions are modified to provide either independent or simultaneous data access to both the databases, based on the specific custom responsibility chosen by the user. This will be explained further in conjunction with FIG. 6. Subsequently backend server 106 routes the query to the databases and fetches requested data, which is then presented to the user.

In a preferred embodiment of the present invention, backend databases 102 are ANSI SQL compliant. SQL stands for Structured Query Language. It will be apparent to one skilled in the art that SQL has been used for exemplary purposes only and in no way should be considered as limiting the scope of the present invention. Any other database query language such as DML or DDL can be used without deviating from the scope of the invention.

Data items are stored in the current and archive databases under predefined headers. Native data queries from the application session are sent in SQL format. The general SQL query format for a single data query directed towards current database 302 is as follows:
select <data item> from <xyz header in current database>

Here <data item> refers to the specific data that the user needs and <xyz header> refers to the specific database header in current database where the data resides.

When normal responsibility 502 for accessing current database 302 is used, this query is routed to current database 302 and all data corresponding to the query is extracted from the specified header.

When custom responsibility 504 is used, these native queries are channeled to interoperable layer 104. Here, the query corresponding to the current database header is reconfigured to a union database query. In other words, the query sees the corresponding headers from the current as well as archive database, for extracting data. In effect, the native queries are converted to a SQL UNION format. A query <query-2> similar to the native SQL query <query-1> is constructed for the corresponding header in the archive database as follows:
select <data item> from <xyz header in archive database>
<query-2> is then combined with the native query <query-1> via a UNION ALL operator
<query-1> UNION ALL <query-2>

This operator serves to merge the results of the two queries into a composite result. A successful archive and purge process ensures data to be available either in current or in archive schema, thus eliminating possibility of any duplications. Next a union database view is created corresponding to the current database header.
create view <xyz header of current database> as (<query-1> UNION ALL <query-2>)

This command creates an integrated view of data from the current as well as archive databases. In other words, the query is pointed at both the databases and is made to run against database instances corresponding to the current and archive databases simultaneously. The combined data list is then transferred back to front-end application session 102, where exhaustive data search results are presented to the user without his having to switch responsibilities and search each database independently.

FIG. 6 is a flowchart that illustrates the seamless data access feature of interoperable layer through an example. In accordance with step 602, the user logs into the front-end application with a responsibility. At step 604 the user submits a query for retrieving order numbers of transactions done with a client X. Some of these transactions are stored in the current database under the table titled “X_order_headers”. Other transactions with X are stored in the archive database under the table titled “X_order_headers_history”. If at step 606, the user logs into the system through a normal responsibility for accessing current database, the native SQL query generated will be as follows:
select order_number from X_order_headers
   At step 608, the backend servers execute this query and the data residing in the corresponding header in the current database is retrieved.

On the other hand, if at step 606, the custom responsibility for accessing combined data is chosen, the query is channeled to the interoperable layer at step 610. Thereafter, in accordance with step 612, the object X_order_headers is directed to an integrated data view, which is created under interoperable layer during the installation phase, as follows.
create view X_order_headers as (select order_number from abc_order_headers UNION ALL select order_number from abc_order_hearders_history)

The native query is thus reinterpreted at the interoperable layer. In other words, the original query, which was directed at just a single database, is now run against both database instances simultaneously at step 614. The entire order history is thus checked and an exhaustive list of order numbers is generated for presenting to the user at step 616.

In this manner, the present invention provides a method for simultaneous access to multiple data sources. Furthermore, the method can be used for combined data access to current as well as archived historical data simultaneously or independently, within a single login session, without having to log in separately to access the databases. In addition, forms and screens that have access to both the databases can be easily executed.

With this functionality of seamless access to the entire data set, enterprises may harness the potential benefits of data archiving to improve performance and availability of critical data. While accessing any of the current or historical databases independently, the dataset, which needs to be searched, is substantially reduced. At the same time, user concerns of getting access to exhaustive data are also aptly answered. Therefore, it helps in providing a cost-effective, long-term solution to the problem of accelerated database growth.

The interoperable layer, as described in the present invention, may be implemented as a computer program product in conjunction with an enterprise application. The interoperable layer executes a set of instructions that are stored in one or more storage elements, in order to perform integrated data searches across disparate data sources. The storage elements may be in the form of a database or a physical memory element present in a processing machine. The set of instructions may include various instructions for performing the steps that constitute the method of generating union queries and presenting integrated search results. The set of instructions may be in the form of a program or an application software. Furthermore, the software might be in the form of a collection of separate programs, a program module with a larger program or a portion of a program module.

While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method for facilitating seamless access to a plurality of disparate data sources within a single login session, the method comprising the steps of:
a. identifying the mode in which access to the plurality of data sources is required, the mode being either simultaneous or independent access to the data sources;
b. receiving a data query, the data query being a single request for data access;
c. converting the query to a format capable of facilitating access to disparate data sources in accordance with the identified mode of data access;
d. routing the converted query to the plurality of data sources; and
e. retrieving data from the plurality of data sources in response to the routed query.

2. The method as recited in claim 1 wherein the step of identifying the mode in which access to the data sources is required comprises the step of receiving the responsibility assumed by a user, the responsibility indicating user preference with respect to data access, the user preference being either to simultaneously access the data sources or independently access at least one of the data sources.

3. The method as recited in claim 1 wherein the received data query is a SQL statement.

4. The method as recited in claim 1 wherein the data sources are relational databases, data items in each relational database having multiple attributes and relationships with other data items of the database.

5. The method as recited in claim 1 wherein the step of converting the query comprises the steps of:
a. constructing a plurality of new queries, each new query corresponding to at least one data source as specified for access in accordance with the user responsibility, the new query being capable of extracting data from the corresponding data source; and
b. integrating the newly constructed queries to form a union query.

6. The method as recited in claim 5 wherein the union query is a UNION ALL SQL statement.

7. A method for providing simultaneous access to data residing in a current database and an archive database, the method comprising the steps of:
a. receiving a data query;
b. constructing a first data query corresponding to the current database;
c. constructing a second data query corresponding to the archive database;
d. integrating the first data query and the second data query to form a union query, the union query being capable of accessing current as well as archive databases;
e. routing the union query to the current database and the archive database simultaneously;
f. retrieving data from the current database and the archive database; and
g. integrating the query results from the current and archive databases.

8. The method as recited in claim 7 wherein the data query received from the user is in an SQL statement.

9. A system for facilitating seamless access to a plurality of disparate data sources within a single login session, the system comprising:
a. means for identifying the mode in which data access is required, the mode being at least one of: I) simultaneous, and II) independent access to the data sources;
b. means for receiving a data query, the data query being a single request for data access;
c. means for converting the query to a format capable of facilitating access to disparate data sources in accordance with the identified mode of data access;
d. means for routing the converted query to the plurality of data sources;
e. means for retrieving data from the plurality of data sources in response to the routed query; and
f. means for presenting the data retrieved from the disparate sources in an integrated format.

10. The system as recited in claim 9 wherein the means for identifying the mode comprises means for receiving the responsibility assumed by a user, the responsibility indicating user preference with respect to data access, the user preference being at least one of: I) simultaneously accessing the data sources, and II) independently accessing at least one of the data sources.

11. The system as recited in claim 9 wherein the query converting means further comprises:
a. means for constructing a plurality of new queries, each new query corresponding to at least one data source as specified for access in accordance with the user responsibility, the new query being capable of extracting data from a specific data source; and
b. means for integrating the newly constructed queries to form a union query.

12. The system as recited in claim 9 wherein the data source is a current database, the current database having live data stored in it.

13. The system as recited in claim 9 wherein the data source is an archive database, the archive database having historical data stored in it.

14. An enterprise application comprising:
a. a plurality of databases;
b. a front end comprising:
i. means for accepting a user responsibility from a user, the responsibility indicating user preference for mode of data access, the mode being at least one of: I) simultaneous and II) independent access to the data sources;
ii. means for accepting a query in a standard format; and
iii. means for presenting results corresponding to the query;
c. an interoperable layer for converting the query accepted from the front end to a format capable of facilitating access to disparate data sources in accordance with the specified mode; and
d. a backend server comprising:
i. means for routing the query obtained from the interoperable layer to the plurality of databases; and
ii. means for retrieving query results from the plurality of databases;
wherein the query results from the plurality of databases are presented to the user in an integrated manner.

15. The application as recited in claim 14 wherein one of the plurality of databases is a current database, the current database having live data stored in it.

16. The application as recited in claim 14 wherein one of the plurality of databases is an archive database, the archive database having historical data stored in it.

17. The application as recited in claim 14 wherein the interoperable layer receives a query in SQL format and converts the query into a UNION SQL format.

18. A computer program product for accessing a plurality of disparate data sources simultaneously or independently within a single login session, the computer program product comprising:
a. program instruction means for identifying the mode in which data access is required by a user;
b. program instruction means for receiving a data query, the data query being a single request for data access by the user;
c. program instruction means for converting the query to a format capable of facilitating access to disparate data sources in accordance with the identified mode of data access;
d. program instruction means for routing the converted query to the plurality of data sources;
e. program instruction means for retrieving data from the plurality of data sources in response to the routed query; and
f. program instruction means for presenting the data retrieved from the disparate sources in an integrated format to the user.

19. The computer program product as recited in claim 18 wherein the query converting program means further comprises:
a. program instruction means for constructing a plurality of new queries, each new query corresponding to at least one data source, the new query being capable of extracting data from a specific data source; and
b. program instruction means for integrating the newly constructed queries with the original query to form a union query.
